(19) United States
(12) Patent Application Publication
(10) Pub. No.: US 2021/0071751 A1
(43) Pub. Date: Mar. 11, 2021

(54) DRIVING DEVICE FOR VEHICLE

(71) Applicant: JTEKT CORPORATION, Osaka (JP)

(72) Inventor: Noriyuki FUJII, Hekinan-shi (JP)

(73) Assignee: JTEKT CORPORATION, Osaka (JP)

(21) Appl. No.: 17/011,159

(22) Filed: Sep. 3, 2020

(30) Foreign Application Priority Data
Sep. 11, 2019 (JP) 2019-165473

(51) Int. Cl. F16H 57/04; B60K 6/26; B60K 6/36; F16H 57/02; B60K 1/00; H02K 5/20; H02K 7/00; H02K 7/116; H02K 9/193

(52) U.S. Cl. CPC F16H 57/0476; B60K 6/26; B60K 6/36; F16H 57/02; F16H 57/0423; B60K 1/00; B60K 6/24; F16H 57/0486; H02K 5/20; H02K 7/006; H02K 7/116; H02K 9/193; F16H 57/0457

(57) ABSTRACT

A driving device for a vehicle includes: an electric motor including a motor shaft having a hollow tubular shape; an output shaft passed through the motor shaft; a transmission mechanism configured to change the speed of rotation of the motor shaft and transmit a driving force of the electric motor to the output shaft; and a housing in which the electric motor and the transmission mechanism are accommodated. The output shaft is offset inside the motor shaft so that a rotation axis of the output shaft deviates from a rotation axis of the motor shaft in the radial direction of the electric motor.

### CROSS-REFERENCE TO RELATED APPLICATION

This application claims priority to Japanese Patent Application No. 2019-165473 filed on Sep. 11, 2019, incorporated herein by reference in its entirety.

### BACKGROUND

### 1. Technical Field

The present disclosure relates to a driving device for a vehicle, the driving device including an electric motor.

### 2. Description of Related Art

There has been conventionally known a driving device configured to drive auxiliary driving wheels of a four-wheel-drive vehicle by use of an electric motor as a drive source (e.g., see Japanese Unexamined Patent Application Publication No. 2014-52063 (JP 2014-52063 A) and Japanese Unexamined Patent Application Publication (Translation of PCT Application) No. 2017-534032 (JP 2017-534032 A)). In a four-wheel-drive vehicle including such a driving device, it is not necessary to connect a main driving wheel side to be driven by an engine to an auxiliary driving wheel side to be driven by the driving device via a propeller shaft, for example. This can increase a vehicle cabin space and also contribute to a reduction in weight of the vehicle.

A driving device for a vehicle as described in JP 2014-52063 A or JP 2017-534032 A includes an electric motor, right and left output shafts, a deceleration mechanism configured to decelerate the rotation of a motor shaft of the electric motor, and a differential mechanism configured to distribute a driving force to the right and left output shafts. The differential mechanism includes a differential case into which the driving force is input from the deceleration mechanism, a pair of pinion gears configured to rotate together with the differential case in an integrated manner, and right and left side gears configured to mesh with the pinion gears. The right and left output shafts are connected respectively to the side gears in a relatively non-rotatable manner.

The motor shaft has a hollow tubular shape, and one of the right and left output shafts is passed through the inside of the motor shaft. Respective driving forces are transmitted to right and left auxiliary driving wheels via respective drive shafts from the right and left output shafts.

### SUMMARY

In the driving device configured as described above, the position of the differential mechanism in the vehicle up-down direction is determined by respective lengths and respective angles of the right and left drive shafts. When the position of the differential mechanism is determined, the position of the electric motor is determined. However, the outside diameter of the electric motor for driving is larger than the outside diameter of the differential mechanism. Accordingly, it might be difficult to secure a space to place the driving device while the minimum under clearance of the vehicle is maintained to be a predetermined value or more. Further, depending on the layout of the vehicle, it might be difficult to secure a space to place the driving device while the volume of a trunk room is maintained to be a predetermined value or more.

The present disclosure can provide a driving device for a vehicle, the driving device being excellent in mountability to a vehicle while the driving device employs a configuration in which an output shaft is passed through a motor shaft of an electric motor.

A driving device for a vehicle according to one aspect of the present disclosure includes an electric motor, an output shaft, a transmission mechanism, and a housing. The electric motor includes a motor shaft having a hollow tubular shape. The output shaft is passed through the motor shaft. The transmission mechanism is configured to change the speed of rotation of the motor shaft and transmit a driving force of the electric motor to the output shaft. In the housing, the electric motor and the transmission mechanism are accommodated. The output shaft is offset inside the motor shaft so that a rotation axis of the output shaft deviates from a rotation axis of the motor shaft in the radial direction of the electric motor.

With the above configuration, it is possible to improve mountability to a vehicle while a configuration in which an output shaft is passed through a motor shaft of an electric motor is employed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating a schematic exemplary configuration of a four-wheel-drive vehicle provided with a driving device according to a first embodiment of the present disclosure;

FIG. 2 is a sectional view illustrating an exemplary configuration of the driving device and illustrates a state where the horizontal section of the driving device is viewed from the upper side toward the lower side in the vertical direction;

FIG. 3A is a perspective view illustrating a surface, on a fifth housing member side, of a fourth housing member together with part of a reduction gear;

FIG. 3B is a perspective view illustrating a surface, on the fourth housing member side, of the fifth housing member;

FIG. 4 is a sectional view illustrating a section of part of the driving device, the part including a projecting piece;

FIG. 5 is a sectional view illustrating a section of part of the driving device along a line A-A in FIG. 4;

FIG. 6A is a perspective view of the projecting piece according to a second embodiment of the present disclosure when the projecting piece is viewed from a diagonally upper side;

FIG. 6B is a sectional view illustrating a section of a peripheral part around the projecting piece along the vertical direction;

FIG. 7A is a perspective view of the projecting piece according to a third embodiment of the present disclosure when the projecting piece is viewed from a diagonally upper side;

FIG. 7B is a sectional view illustrating a section of a peripheral part around the projecting piece along the vertical direction; and

FIG. 8 is a sectional view illustrating a section of part of the driving device, the part including the projecting piece, according to the third embodiment of the present disclosure, the section being a section perpendicular to respective rotation axes of a motor shaft and a first output shaft.

### DETAILED DESCRIPTION OF EMBODIMENTS

### First Embodiment

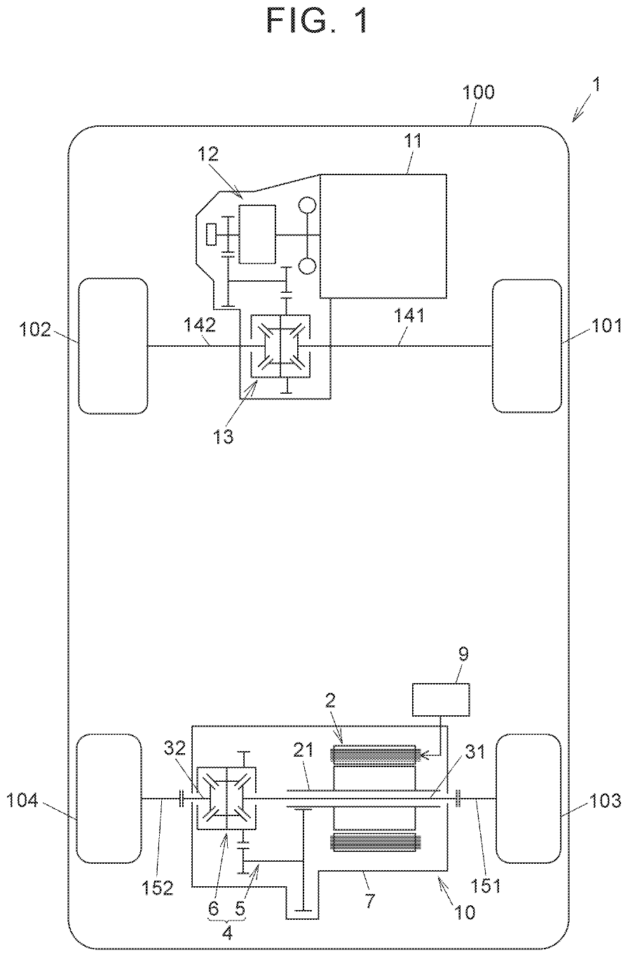

A first embodiment of the present disclosure will be described with reference to FIGS. 1 to 5. Note that the embodiment described below includes some parts that specifically describe technical matters to carry out the present disclosure, but the technical scope of the present disclosure is not limited to such concrete modes.

FIG. 1 is a schematic view illustrating a schematic exemplary configuration of a four-wheel-drive vehicle provided with a driving device according to the first embodiment of the present disclosure. The four-wheel-drive vehicle 1 is configured such that a right front wheel 101 and a left front wheel 102 as main driving wheels are driven by a driving force of an engine 11 as a main drive source, and a right rear wheel 103 and a left rear wheel 104 as auxiliary driving wheels are driven by a driving device 10 including an electric motor 2 as an auxiliary drive source.

The driving force of the engine 11 is transmitted from a transmission 12 to a differential device 13 and is distributed into the right front wheel 101 and the left front wheel 102 from the differential device 13 via right and left drive shafts 141, 142. Note that, as the main drive source, a high-output electric motor may be used, or a so-called hybrid electric motor constituted by combining an engine and a high-output electric motor may be used.

The driving device 10 includes the electric motor 2 including a motor shaft 21 extending in the vehicle width direction, a pair of output shafts 31, 32, a transmission mechanism 4 configured to change the speed of rotation of the motor shaft 21 and transmit a driving force of the electric motor 2 to the output shafts 31, 32, and a housing 7 in which the electric motor 2 and the transmission mechanism 4 are accommodated. The housing 7 is fixed to a vehicle body 100 and is non-rotatable relative to the vehicle body 100. The electric motor 2 receives supply of a motor current from a control device 9, and the electric motor 2 is controlled by the control device 9.

The transmission mechanism 4 includes a deceleration mechanism portion 5 configured to decelerate the rotation of the motor shaft 21, and a driving force distribution mechanism portion 6 configured to distribute the driving force of the electric motor 2 to the output shafts 31, 32, the driving force being input from the deceleration mechanism portion 5. The driving force of the electric motor 2 is transmitted to the right rear wheel 103 and the left rear wheel 104 from right and left drive shafts 151, 152 via the transmission mechanism 4. One output shaft 31 out of the output shafts 31, 32 is connected to the right drive shaft 151, and the other output shaft 32 out of the output shafts 31, 32 is connected to the left drive shaft 152. Hereinafter, the one output shaft 31 is referred to as the first output shaft 31, and the other output shaft 32 is referred to as the second output shaft 32.

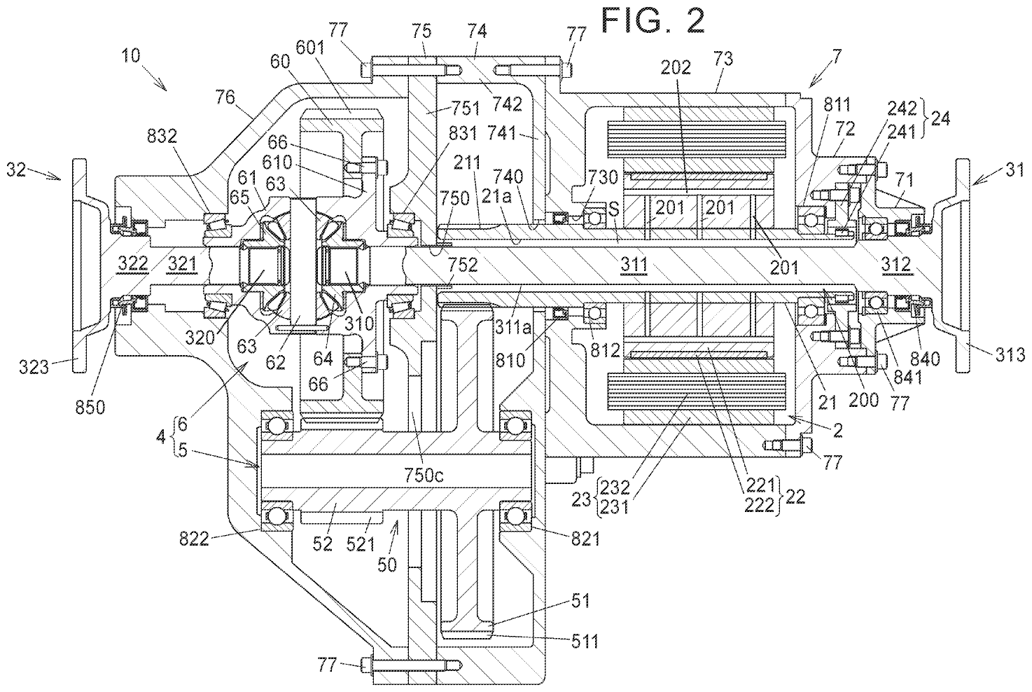

FIG. 2 is a sectional view illustrating an exemplary configuration of the driving device 10 and illustrates a state where the horizontal section of the driving device 10 is viewed from the upper side toward the lower side in the vertical direction. In FIG. 2, the upper side in the figure corresponds to the front side in the vehicle front-rear direction, and the right side and the left side in the figure correspond to the right side and the left side in the vehicle width direction. Hereinafter, the “upper side” and the “lower side” indicate the “upper side” and the “lower side” in the vehicle up-down direction along the vertical direction. Further, the “right side” and the “left side” indicate the “right side” and the “left side” in the vehicle width direction (along the vehicle right-left direction).

The housing 7 includes first to sixth housing members 71 to 76 sequentially from the right side, and the housing members 71 to 76 are fixed to each other by a plurality of bolts 77. The first to sixth housing members 71 to 76 are made of aluminum alloy, for example, and are formed by die-casting. The electric motor 2 is accommodated in the third housing member 73, and a right opening of the third housing member 73 is closed by the first and second housing members 71, 72. The transmission mechanism 4 is accommodated in the fourth to sixth housing members 74 to 76.

The electric motor 2 includes the motor shaft 21 having a hollow tubular shape, a rotor 22 configured to rotate together with the motor shaft 21 in an integrated manner, a stator 23 placed on the outer periphery of the rotor 22, and a rotation sensor 24 configured to detect the rotation of the motor shaft 21. The core of the motor shaft 21 is a hollow portion 200. The rotor 22 includes a rotor core 221, and a plurality of permanent magnets 222 fixed to the rotor core 221. The stator 23 includes a stator core 231, and coils 232 of a plurality of phases, the coils 232 being wound around the stator core 231.

The stator core 231 is fixed to the third housing member 73. A motor current is supplied to the coils 232 of the phases from the control device 9. The rotation sensor 24 is constituted by a resolver rotor 241 fixed to the motor shaft 21, and a resolver sensor 242 fixed to the second housing member 72. A detection signal of the resolver sensor 242 is sent to the control device 9. The control device 9 controls the electric motor 2 based on vehicle information. Vehicle information includes rotation speeds of the right and left front and rear wheels 101 to 104, an accelerator operation amount, a steering angle, and so on.

The motor shaft 21 is rotatably supported by a bearing 811 and a bearing 812. The bearing 811 is placed between the motor shaft 21 and the second housing member 72, and the bearing 812 is placed between the motor shaft 21 and the third housing member 73. An insertion hole 730 through which the motor shaft 21 is passed is provided in a left end portion of the third housing member 73, and a sealing member 810 is placed by the side of the bearing 812 between the inner peripheral surface of the insertion hole 730 and the outer peripheral surface of the motor shaft 21.

The deceleration mechanism portion 5 decelerates the rotation of the motor shaft 21 by a reduction gear 50 and transmits the driving force of the electric motor 2 to the driving force distribution mechanism portion 6. The reduction gear 50 integrally includes a discal large-diameter gear wheel portion 51 and a cylindrical small-diameter gear wheel portion 52. In the present embodiment, the reduction gear 50 is placed behind the motor shaft 21 in the vehicle front-rear direction. The large-diameter gear wheel portion 51 is configured such that gear teeth 511 provided in an outer peripheral end portion of the large-diameter gear wheel portion 51 mesh with gear teeth 211 provided in a left end portion of the motor shaft 21. Gear teeth 521 are provided in an outer peripheral end portion of part of the small-diameter gear wheel portion 52 in the axial direction, and the pitch circle diameter of the small-diameter gear wheel portion 52 is set to be smaller than the pitch circle diameter of the large-diameter gear wheel portion 51.

The reduction gear 50 is rotatably supported by a bearing 821 and a bearing 822. The bearing 821 is placed between the reduction gear 50 and the fourth housing member 74, and the bearing 822 is placed between the reduction gear 50 and the sixth housing member 76. Note that the gear teeth 511 of the large-diameter gear wheel portion 51 and the gear teeth 521 of the small-diameter gear wheel portion 52 are helical teeth having a flank line inclined from the axial direction, for example. However, the gear teeth 511 and the gear teeth 521 may be spur teeth.

The driving force distribution mechanism portion 6 is configured as a differential gear mechanism (a differential) and is configured to distribute a driving force input therein to the first and second output shafts 31, 32 by permitting a difference therebetween. The driving force distribution mechanism portion 6 includes a ring gear 60 configured to mesh with the small-diameter gear wheel portion 52 of the reduction gear 50, a differential case 61 configured to rotate together with the ring gear 60 in an integrated manner, a pinion shaft 62 fixed to the differential case 61, a pair of pinion gears 63 pivotally supported by the pinion shaft 62, and right and left side gears 64, 65 configured to mesh with the pinion gears 63.

The ring gear 60 is fixed to a flange portion 610 of the differential case 61 by bolts 66, and gear teeth 601 provided in an outer peripheral end portion of the ring gear 60 mesh with the gear teeth 521 of the small-diameter gear wheel portion 52 in the reduction gear 50. The outside diameter of the ring gear 60 is formed to be smaller than the outside diameter of the electric motor 2 (the outside diameter of the stator 23). The differential case 61 is rotatably supported by a bearing 831 and a bearing 832. The bearing 831 is placed between the differential case 61 and the fifth housing member 75, and the bearing 832 is placed between the differential case 61 and the sixth housing member 76.

The first output shaft 31 is splined to the right side gear 64 and rotates together with the side gear 64 in an integrated manner, and the second output shaft 32 is splined to the left side gear 65 and rotates together with the side gear 65 in an integrated manner.

The first output shaft 31 includes a spline portion 310 configured to be splined to the right side gear 64, a columnar shaft portion 311, a large portion 312 having the outside diameter larger than that of the shaft portion 311, and a flange portion 313 connected to the right drive shaft 151 outside the housing 7. A sealing member 840 and a bearing 841 are placed between the large portion 312 of the first output shaft 31 and the first housing member 71.

Similarly, the second output shaft 32 includes a spline portion 320 configured to be splined to the left side gear 65, a columnar shaft portion 321, a large portion 322 having the outside diameter larger than that of the shaft portion 321, and a flange portion 323 connected to the left drive shaft 152 outside the housing 7. A sealing member 850 is placed between the large portion 322 of the second output shaft 32 and the sixth housing member 76.

Lubricant that lubricates each part of the transmission mechanism 4 is filled in the housing 7. The leakage of the lubricant from the housing 7 is restrained by the sealing members 840, 850. Further, the lubricant is also used for cooling the electric motor 2 as will be described later.

The shaft portion 311 of the first output shaft 31 is passed through the hollow portion 200 of the motor shaft 21. The outside diameter of the shaft portion 311 is smaller than the inside diameter of the motor shaft 21. A space S is formed between an outer peripheral surface 311a of the shaft portion 311 and an inner peripheral surface 21a of the motor shaft 21. At the time of assembling of the driving device 10, the first output shaft 31 is inserted into the hollow portion 200 from the spline portion 310 side.

The housing 7 has a lubricant supply structure configured to supply the lubricant in the fourth housing member 74 to the hollow portion 200 of the motor shaft 21 from the space S between the inner peripheral surface 21a of the motor shaft 21 and the outer peripheral surface 311a of the shaft portion 311 of the first output shaft 31. FIG. 2 illustrates part of a projecting piece 752 constituting the lubricant supply structure. A distal end portion of the projecting piece 752 is inserted into the space S. Details of the lubricant supply structure will be described later.

The lubricant supplied to the hollow portion 200 flows through the space S and reaches a part corresponding to the inside of the rotor 22. The motor shaft 21 and the rotor 22 are respectively provided with a plurality of radial holes 201 and a plurality of axial holes 202 through which the lubricant flows. The radial holes 201 communicate with the axial holes 202. The lubricant flows into the radial holes 201 from the hollow portion 200 and flows radially outwardly by centrifugal force. The lubricant further flows through the axial holes 202 so as to cool down the rotor 22. The axial holes 202 are opened on the opposite axial end surfaces of the rotor core 221, and the lubricant discharged from the axial holes 202 flows back into the fourth housing member 74 through an oil hole (described later) provided in the fourth housing member 74.

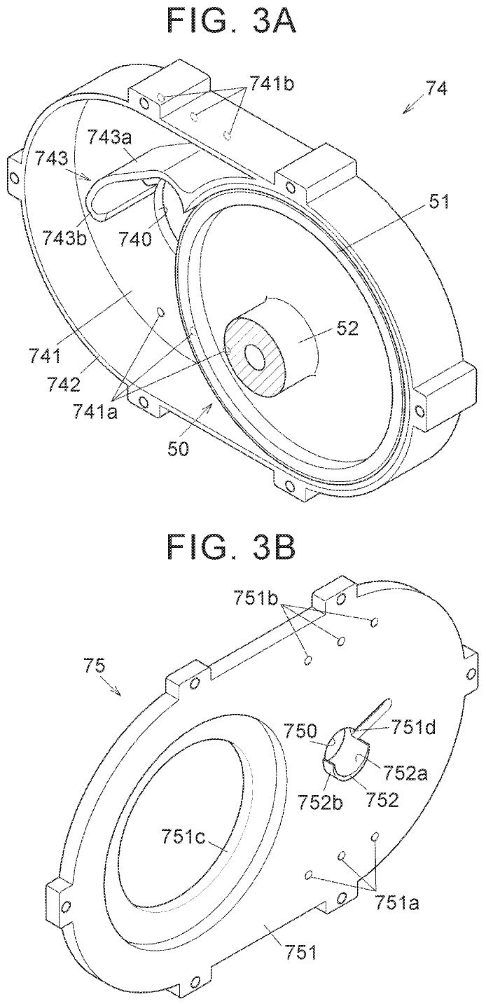

Next will be described details of the lubricant supply structure configured to supply the lubricant in the fourth housing member 74 to the hollow portion 200 of the motor shaft 21, with reference to FIGS. 3A, 3B, 4, and 5.

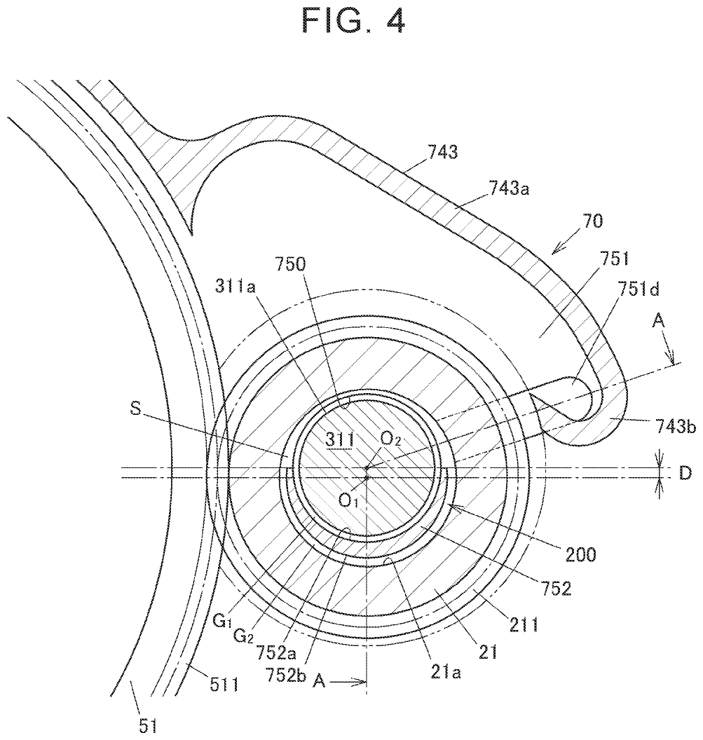

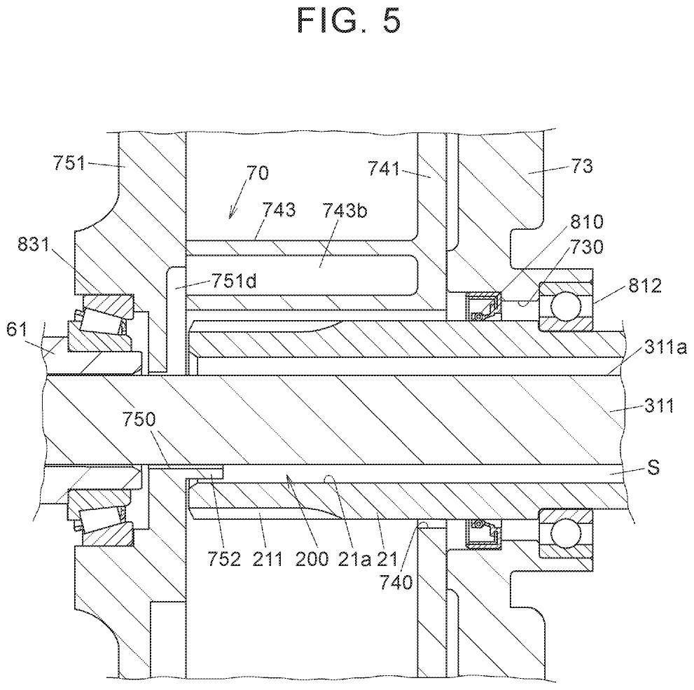

FIG. 3A is a perspective view illustrating a surface, on the fifth housing member 75 side, of the fourth housing member 74 together with part of the reduction gear 50. FIG. 3B is a perspective view illustrating a surface, on the fourth housing member 74 side, of the fifth housing member 75. FIG. 4 is a sectional view illustrating a section of part of the driving device 10, the part including the projecting piece 752. FIG. 5 is a sectional view illustrating a section of part of the driving device 10 along a line A-A in FIG. 4.

FIG. 4 illustrates a state where a section perpendicular to a rotation axis θ₁ of the motor shaft 21 and a rotation axis θ₂ of the first output shaft 31 is viewed from the right sight to the left side, and the lower side in the figure corresponds to the lower side in the vertical direction. The rotation axis θ₁ of the motor shaft 21 corresponds to the central axis of the electric motor 2. The motor shaft 21 and the rotor 22 rotate around the rotation axis θ₁.

The rotation axis θ₂ of the first output shaft 31 is parallel to the rotation axis θ₁ of the motor shaft 21. However, the rotation axis θ₂ does not coincide with the rotation axis θ₁, and in the present embodiment, the rotation axis θ₂ is placed above the rotation axis θ₁. That is, the first output shaft 31 is offset toward one side inside the motor shaft 21 so that the rotation axis θ₂ deviates from the rotation axis θ₁ of the motor shaft 21 in the radial direction of the electric motor 2. Each constituent component of the driving force distribution mechanism portion 6 rotates around the rotation axis θ₂.

The fourth housing member 74 integrally includes a flat wall portion 741 having an insertion hole 740 through which the motor shaft 21 is passed, and a peripheral wall portion 742 extending toward the fifth housing member 75 side from the outer edge of the wall portion 741. The wall portion 741 has a plurality of oil holes 741a through which the lubricant circulates, and a plurality of air holes 741b.

The fifth housing member 75 includes a flat body portion 751 having an insertion hole 750 through which the shaft portion 311 of the first output shaft 31 is passed, and the outer edge of the body portion 751 abuts with the peripheral wall portion 742 of the fourth housing member 74. The body portion 751 has a plurality of oil holes 751a through which the lubricant circulates, a plurality of air holes 751b, and an opening 751c through which the small-diameter gear wheel portion 52 of the reduction gear 50 is passed.

As illustrated in FIG. 4, the lubricant supply structure includes the projecting piece 752 provided in the fifth housing member 75, and an oil guide portion 70 configured to guide the lubricant scooped up by the large-diameter gear wheel portion 51 of the reduction gear 50 to the projecting piece 752. The oil guide portion 70 is constituted by a collection portion 743 configured to collect the lubricant scooped up by the large-diameter gear wheel portion 51 of the reduction gear 50, and a guide groove 751d configured to guide the lubricant collected by the collection portion 743 to the projecting piece 752. The collection portion 743 is provided integrally with the wall portion 741 such that the collection portion 743 projects toward the fifth housing member 75 from the wall portion 741 of the fourth housing member 74. The guide groove 751d is a groove provided in the body portion 751 of the fifth housing member 75.

The projecting piece 752 has an arcuate shape when the projecting piece 752 is viewed along the rotation axes θ₁, θ₂ and extends from the body portion 751 toward the fourth housing member 74 side. That is, the projecting piece 752 is provided in a gutter shape. At least part of the projecting piece 752 is inserted into the space S in a part where a distance between the inner peripheral surface 21a of the motor shaft 21 and the outer peripheral surface 311a of the first output shaft 31 is enlarged due to offsetting of the first output shaft 31 relative to the motor shaft 21. In other words, the first output shaft 31 is offset in a direction distanced from the projecting piece 752.

The projecting piece 752 is placed at least between the outer peripheral surface 311a in a lower end portion of the shaft portion 311 of the first output shaft 31 and the inner peripheral surface 21a of the motor shaft 21. In the present embodiment, the shape of the projecting piece 752 when the projecting piece 752 is viewed along the rotation axes θ₁, θ₂ is a semicircular shape opened upward. An inner surface 752a of the projecting piece 752 faces the outer peripheral surface 311a of the shaft portion 311 of the first output shaft 31 via a gap G₁, and an outer surface 752b of the projecting piece 752 faces the inner peripheral surface 21a of the motor shaft 21 via a gap G₂. Note that, in the present embodiment, the projecting piece 752 is formed integrally with the body portion 751, but the projecting piece 752 may be provided separately from the body portion 751.

The collection portion 743 includes an eaves portion 743a provided to cover the upper side of the insertion hole 740, and a curved portion 743b continuous with the eaves portion 743a. The shape of the eaves portion 743a when the eaves portion 743a is viewed along the rotation axes θ₁, θ₂ is a linear shape inclined downward toward the curved portion 743b side, and the shape of the curved portion 743b is a C-shape opened diagonally upward along the eaves portion 743a. The lubricant scooped up by the large-diameter gear wheel portion 51 of the reduction gear 50 is attached to a bottom face of the eaves portion 743a and flows down toward the curved portion 743b side by gravity.

As illustrated in FIGS. 4 and 5, the curved portion 743b communicates with the guide groove 751d, and the lubricant collected by the collection portion 743 flows into the guide groove 751d from the curved portion 743b. The guide groove 751d is inclined from the horizontal direction so that part of the guide groove 751d, the part communicating with the curved portion 743b, is placed above the projecting piece 752. Hereby, the lubricant collected by the collection portion 743 flows in above the projecting piece 752 through the guide groove 751d and is supplied from the projecting piece 752 to the hollow portion 200. The lubricant supplied to the hollow portion 200 cools down the electric motor 2 as described above and flows back into the fourth housing member 74 from the oil holes 741a.

Operation and Effect of First Embodiment

In the first embodiment of the present disclosure as described above, the first output shaft 31 is offset in the radial direction of the electric motor 2 inside the motor shaft 21. Accordingly, a relative position between the driving force distribution mechanism portion 6 and the electric motor 2 can be adjusted within a range of a distance D (illustrated in FIG. 4) between the rotation axis θ₁ and the rotation axis θ₂, so that the degree of freedom of vehicle layout is increased, thereby improving mountability in the vehicle. Particularly, in the present embodiment, the first output shaft 31 is offset upward in the vehicle up-down direction from the motor shaft 21, so that the electric motor 2 can be lowered downward relatively to the driving force distribution mechanism portion 6. This makes it possible to increase the volume of a trunk room of the four-wheel-drive vehicle 1, for example.

Further, in the present embodiment, the first output shaft 31 is offset in the radial direction of the electric motor 2 inside the motor shaft 21. Accordingly, the width of the space S between the outer peripheral surface 311a of the shaft portion 311 of the first output shaft 31 and the inner peripheral surface 21a of the motor shaft 21 is partially increased, and the projecting piece 752 can be inserted into a part where the width of the space S is increased. This makes it possible to supply more lubricant into the motor shaft 21 while an increase in the diameter of the motor shaft 21 is restrained.

### Second Embodiment

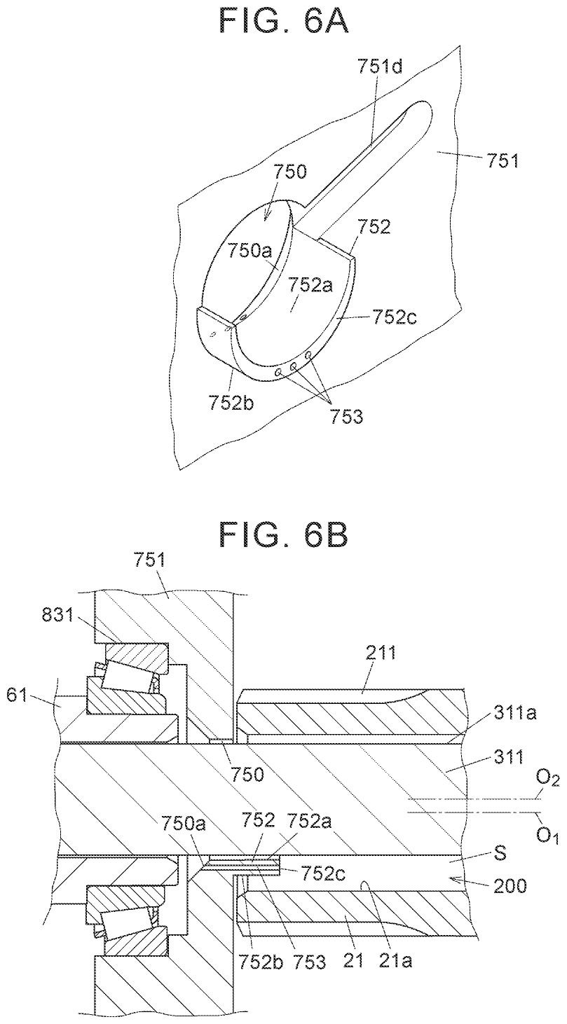

Next will be described a second embodiment of the present disclosure with reference to FIGS. 6A, 6B. The second embodiment is different from the first embodiment in a configuration where a plurality of oil holes 753 through which lubricant flows is provided in the projecting piece 752. The other configurations are the same as those of the first embodiment. Accordingly, in FIGS. 6A, 6B, constituents common to those described in the first embodiment have the same reference signs as the reference signs used in the first embodiment, and redundant descriptions are omitted.

FIG. 6A is a perspective view of the projecting piece 752 according to the present embodiment when the projecting piece 752 is viewed from a diagonally upper side. FIG. 6B is a sectional view illustrating a section of a peripheral part around the projecting piece 752 along the vertical direction. In FIGS. 6A, 6B, the lower side in the figures corresponds to the lower side in the vertical direction.

In the present embodiment, as illustrated in FIG. 6B, an inner surface 750a of an opening on the left side (the driving force distribution mechanism portion 6 side) in the insertion hole 750 is formed in a tapered shape. The projecting piece 752 has three oil holes 753, and each of the oil holes 753 penetrates through the projecting piece 752 along the axial direction parallel to the rotation axis θ₁ of the motor shaft 21 and the rotation axis θ₂ of the first output shaft 31. A first end of the oil hole 753 is opened on the inner surface 750a of the insertion hole 750, and a second end of the oil hole 753 is opened on a distal surface 752c of the projecting piece 752.

Part of the lubricant flowing into the projecting piece 752 from the guide groove 751d is supplied into the motor shaft 21 from between the inner surface 752a of the projecting piece 752 and the outer peripheral surface 311a of the shaft portion 311 of the first output shaft 31, and another part of the lubricant flows from an opening, of the oil hole 753, on a side close to the inner surface 750a of the insertion hole 750 to an opening, of the oil hole 753, on the distal surface 752c side, so that another part of the lubricant is supplied into the motor shaft 21.

In the present embodiment described above, since part of the lubricant flowing toward the left side of the insertion hole 750 from the guide groove 751d is supplied into the motor shaft 21 via the oil holes 753, more lubricant than that in the first embodiment can be supplied into the motor shaft 21. Further, in a case where the first output shaft 31 rotates at a high speed, the lubricant between the inner surface 752a of the projecting piece 752 and the outer peripheral surface 311a of the shaft portion 311 of the first output shaft 31 may become difficult to flow toward the hollow portion 200 side due to receipt of the centrifugal force caused by the rotation of the first output shaft 31. However, in the present embodiment, since the lubricant flowing through the oil holes 753 does not receive the centrifugal force caused by the rotation of the first output shaft 31, the lubricant can be smoothly supplied into the motor shaft 21.

### Third Embodiment

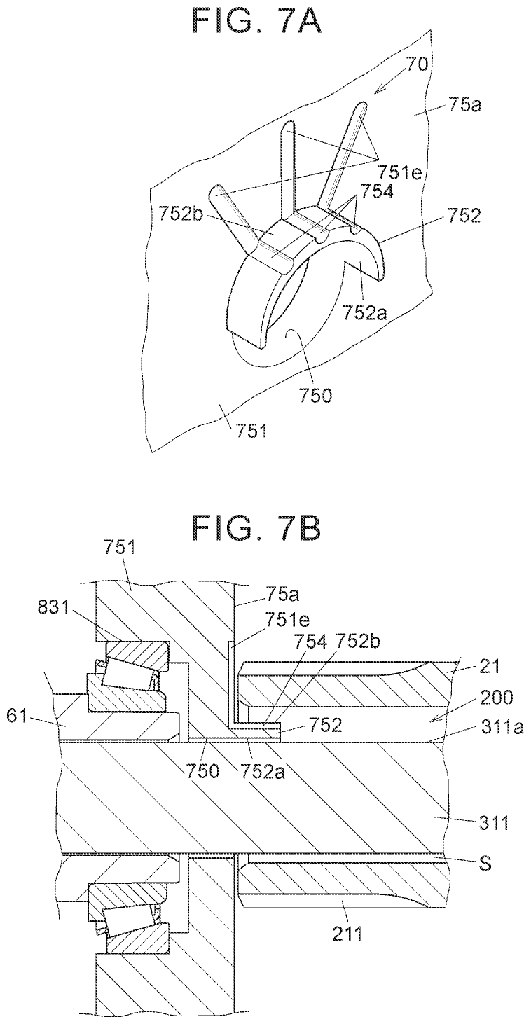

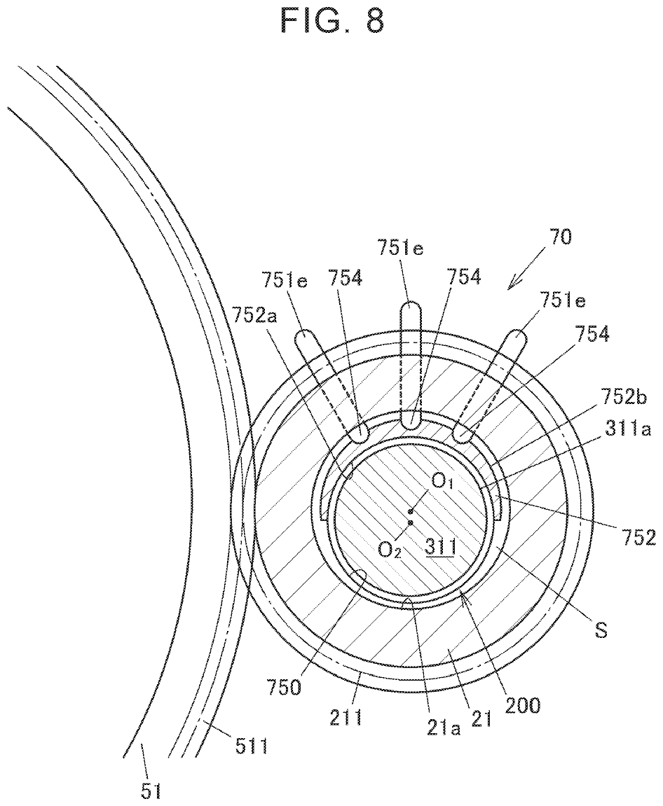

Next will be described a third embodiment of the present disclosure with reference to FIGS. 7A, 7B, and 8. The first and second embodiments describe a case where the first output shaft 31 is offset upward in the vehicle up-down direction from the motor shaft 21. However, in the present embodiment, the first output shaft 31 is offset downward in the vehicle up-down direction from the motor shaft 21, and the projecting piece 752 is placed between the outer peripheral surface 311a in an upper end portion of the shaft portion 311 of the first output shaft 31 and the inner peripheral surface 21a of the motor shaft 21.

FIG. 7A is a perspective view of the projecting piece 752 according to the present embodiment when the projecting piece 752 is viewed from a diagonally upper side. FIG. 7B is a sectional view illustrating a section of a peripheral part around the projecting piece 752 along the vertical direction. FIG. 8 is a sectional view illustrating a section of part of the driving device, the part including the projecting piece 752, the section being a section perpendicular to the rotation axis θ₁ of the motor shaft 21 and the rotation axis θ₂ of the first output shaft 31. In FIGS. 7A, 7B, and 8, the lower side in the figures corresponds to the lower side in the vertical direction.

In the present embodiment, the projecting piece 752 has an arcuate shape projecting upward, and a plurality of oil grooves 754 is provided on the outer surface 752b of the projecting piece 752 such that the oil grooves 754 extend along the axial direction parallel to the rotation axis θ₁ of the motor shaft 21 and the rotation axis θ₂ of the first output shaft 31. Further, in the present embodiment, the oil guide portion 70 configured to guide the lubricant scooped up by the large-diameter gear wheel portion 51 of the reduction gear 50 to the projecting piece is constituted by a plurality of collection grooves 751e provided in the body portion 751 of the fifth housing member 75 such that the collection grooves 751e communicate with the oil grooves 754, respectively.

In the present embodiment, the lubricant scooped up by the large-diameter gear wheel portion 51 of the reduction gear 50 is attached to a surface 75a, on the fourth housing member 74 side, of the body portion 751 of the fifth housing member 75 and flows down by gravity so as to flow into the collection grooves 751e. The lubricant is then supplied from the collection grooves 751e into the motor shaft 21 via the oil grooves 754 provided on the outer surface 752b corresponding to an upper surface of the projecting piece 752.

In the present embodiment, three oil grooves 754 are provided over the outer surface 752b of the projecting piece 752 in the axial direction such that the three oil grooves 754 are parallel to each other, and three collection grooves 751e are provided so as to correspond to the three oil grooves 754, respectively. Further, the three collection grooves 751e are formed in a radial manner around the rotation axis θ₁ of the motor shaft 21 above the projecting piece 752. Note that the number of the oil grooves 754 and the number of the collection grooves 751e may be one or two or may be four or more.

In the present embodiment described above, similarly to the first and second embodiments, it is possible to supply a large amount of lubricant into the motor shaft 21 while an increase in the diameter of the motor shaft 21 is restrained. Further, since the rotation axis θ₁ of the motor shaft 21 is placed above the rotation axis θ₂ of the first output shaft 31, the minimum under clearance of the four-wheel-drive vehicle 1 can be made high, for example.

Additional Matters

The present disclosure has been described based on the embodiments, but the embodiments described above do not limit the disclosure according to Claims. Further, it should be noted that all combinations of features described in the embodiments may not necessarily be essential to the means for solving the problem of the disclosure.

Further, the present disclosure can be carried out with various modifications within a range that does not deviate from the gist of the present disclosure. For example, the first to third embodiments describe a case where the first output shaft 31 is offset in the vehicle up-down direction from the motor shaft 21. However, the present disclosure is not limited to this. The first output shaft 31 may be offset in the vehicle front-rear direction from the motor shaft 21, or the first output shaft 31 may be offset in the vehicle up-down direction and in the vehicle front-rear direction from the motor shaft 21. Further, the reduction gear 50 may not be placed behind the motor shaft 21 in the vehicle front-rear direction. The reduction gear 50 may be placed in front of the motor shaft 21 in the vehicle front-rear direction or may be placed by the side of the motor shaft 21 in the vehicle up-down direction.

Further, the above embodiments describe a case where the driving force distribution mechanism portion 6 is configured as a differential gear mechanism (a differential). However, the present disclosure is not limited to this. For example, the driving force distribution mechanism portion 6 may be configured to distribute a driving force input by a plurality of multiple disc clutches to the first and second output shafts 31, 32. Furthermore, the above embodiments describe a case where the transmission mechanism 4 is constituted by the deceleration mechanism portion 5 and the driving force distribution mechanism portion 6. However, the present disclosure is not limited to this. The transmission mechanism 4 may not include either the deceleration mechanism portion 5 or the driving force distribution mechanism portion 6, for example. In a case where the transmission mechanism 4 does not include the driving force distribution mechanism portion 6, the driving device 10 is provided so as to correspond to one of the wheels, and the driving force of the electric motor 2 is output in the one of the wheels via one output shaft (the first output shaft 31) passed through the motor shaft 21.

What is claimed is:

1. A driving device for a vehicle, the driving device comprising:
an electric motor including a motor shaft having a hollow tubular shape;
an output shaft passed through the motor shaft;
a transmission mechanism configured to change a speed of rotation of the motor shaft and transmit a driving force of the electric motor to the output shaft; and
a housing in which the electric motor and the transmission mechanism are accommodated, wherein the output shaft is offset inside the motor shaft so that a rotation axis of the output shaft deviates from a rotation axis of the motor shaft in a radial direction of the electric motor.

2. The driving device according to claim 1, wherein:
the housing has a lubricant supply structure configured to supply lubricant lubricating the transmission mechanism into the motor shaft from a space between an inner peripheral surface of the motor shaft and an outer peripheral surface of the output shaft;
the lubricant supply structure includes a projecting piece having a distal end portion inserted into the space; and
at least part of the projecting piece is inserted into the space in a part where a distance between the inner peripheral surface and the outer peripheral surface is enlarged due to offsetting of the output shaft relative to the motor shaft.

3. The driving device according to claim 2, wherein:
the transmission mechanism includes a deceleration mechanism portion configured to decelerate the rotation of the motor shaft by a reduction gear including a large-diameter gear wheel portion and a small-diameter gear wheel portion;
the lubricant supply structure includes an oil guide portion configured to guide lubricant scooped up by the large-diameter gear wheel portion to the projecting piece.

4. The driving device according to claim 2, wherein the projecting piece has an oil hole through which the lubricant flows so that the lubricant is supplied to the motor shaft.

5. The driving device according to claim 1, wherein the transmission mechanism includes a driving force distribution mechanism portion configured to distribute the driving force of the electric motor to a pair of output shafts including the output shaft.

6. The driving device according to claim 1, wherein the output shaft is offset in a vehicle up-down direction from the motor shaft.
